(19) United States
(12) Patent Application Publication
(10) Pub. No.: US 2012/0226623 A1
(43) Pub. Date: Sep. 6, 2012

(54) METHODS AND SYSTEMS FOR EXPLORING CAREER OPTIONS

(75) Inventors: Russell Jurney, Mountain View, CA (US); Monica Rogati, Sunnyvale, CA (US); Dhanurjay A.S. Patil, Belmont, CA (US); Chris Riccomini, Moutain View, CA (US); Joshua Lee Fleetwood, Mountain View, CA (US); Peter N. Skomoroch, Mountain View, CA (US); Micah Alpern, Mountain View, CA (US)

(73) Assignee: Linkedln Corporation, Mountain View, CA (US)

(21) Appl. No.: 13/251,954

(22) Filed: Oct. 3, 2011

Related U.S. Application Data
(60) Provisional application No. 61/389,088, filed on Oct. 1, 2010.

(51) Int. Cl. G06Q 10/06

(52) U.S. Cl. 705/321

(57) ABSTRACT

Techniques for presenting career information are described. Consistent with some embodiments, the profile data of members of a social network service is analyzed to generate a set of probabilities for use in predicting career transitions. Based on some profile data (e.g., academic major, academic degree, desired industry, etc.) provided by a user, the derived probabilities are used to predict a set of job titles likely to be of interest to the user. By repeating this process, the user can generate a career path, which is displayed in a visual and interactive manner, enabling the user to explore various aspects of different careers, industries and jobs.

### RELATED APPLICATIONS

This patent application claims the benefit of priority, under 35 U.S.C. §119(e), to U.S. Provisional Patent Application Ser. No. 61/389,088, entitled “METHODS AND SYSTEMS FOR EXPLORING CAREER OPTIONS,” filed on Oct. 1, 2010, which is hereby incorporated by reference herein in its entirety.

### TECHNICAL FIELD

The present disclosure generally relates to data processing systems and techniques for processing and presenting content within an online social network environment. More specifically, the present disclosure relates to methods and systems for analyzing and aggregating the biographical information concerning the professional or employment positions (e.g., job titles) that individual members of a social network service have held over a career, so as to present the aggregated information in an interactive manner that enables members of the social network service to explore a wide variety of career-related information and options, including information representative of one or more possible, next employment positions.

### BACKGROUND

A social network service is a computer- or web-based application that enables its members or users to establish links or connections with persons for the purpose of sharing information with one another. In general, a social network service enables people to memorialize or acknowledge the relationships that exist in their “offline” (i.e., real-world) lives by establishing a computer-based representation of these same relationships in the “online” world. Many social network services require or request that each user provide personal information about the user, such as professional information including information regarding their educational background, employment positions that the user has held, and so forth. This information is frequently referred to as “profile” information, or “member profile” information. In many instances, social network services enable users, with the appropriate data access rights, to view the personal information (e.g., member profiles) of other users. Although such personal information about individual users can be useful in certain scenarios, it may not provide many insights into “big picture” questions about various professions, careers, and individual jobs or employment positions.

### DESCRIPTION OF THE DRAWINGS

Some embodiments are illustrated by way of example and not limitation in the Figures of the accompanying drawings, in which:

FIG. 1 is a functional block diagram illustrating various functional modules or components of a social/business network service, with which an embodiment of the invention might be implemented;

FIG. 2 is a flow diagram illustrating the method operations that occur during a method for analyzing member profile information for the purpose of conditioning the member profile information for use in predicting and/or identifying the job titles that a user might select to be in a career path, according to some embodiments of the invention;

FIG. 3 is a flow diagram illustrating the method operations that occur, at run-time, during a method for generating a visual representation of a career path for a user, according to some embodiments of the invention;

FIG. 4 is an example of a user interface for a web-based career explorer application via which a user is prompted to provide various profile attribute information, for use by the career explorer application in predicting or identifying a set of job titles likely to be of interest to the user;

FIG. 5 is an example of a user interface for a web-based career explorer application presenting a user with a first set of user-selectable job titles, representing employment positions, for inclusion in a career path for the user;

FIG. 6 is an example of a user interface for a web-based career explorer application presenting a user with a second set of user-selectable job titles for inclusion in a career path for the user, according to some embodiments of the invention

FIG. 7 is an example user interface for a web-based career explorer application presenting a visual representation of a career path for a user;

FIG. 8 is an example user interface for a web-based career explorer application presenting a visual representation of an interactive career path for a user and information about persons with whom the user is connected and who have some connection with a particular job title in the user's career path, according to some embodiments;

FIG. 9 is an example user interface for a web-based career explorer application presenting a visual representation of an interactive career path for a user and information about companies that have some association with a particular job title in the user's career path, according to some embodiments;

FIG. 10 is an example user interface for a web-based career explorer application presenting the user-defined or user-generated career paths of others, according to some embodiments;

FIG. 11 is an example user interface for a web-based career explorer application presenting various statistical information about different aspects of a career, industry or job title, which have been determined to be relevant to a career path generated by a user;

FIG. 12 is an example user interface for a web-based career explorer application presenting several job listings for employment positions related to a selected job title in the career path, and various groups, according to some embodiments of the invention; and

FIG. 13 is a block diagram of a machine in the form of a computing device within which a set of instructions, for causing the machine to perform any one or more of the methodologies discussed herein, may be executed.

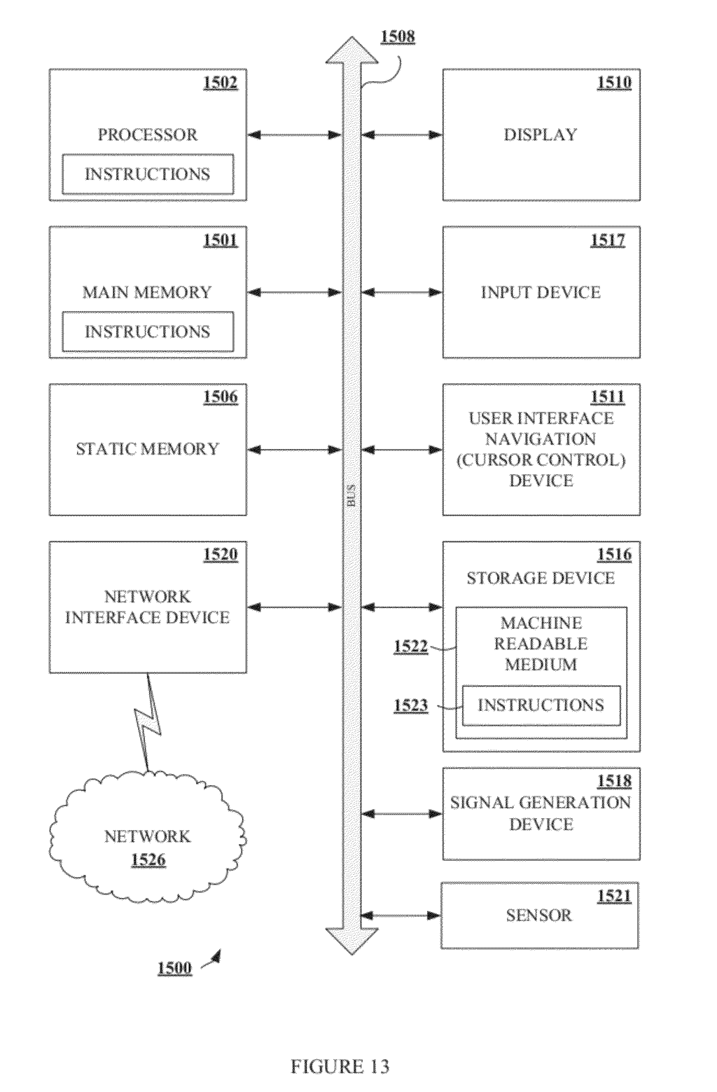

### DETAILED DESCRIPTION

Methods and systems for presenting a user of a career explorer application with customized career path options and other career-related information are described. In the following description, for purposes of explanation, numerous specific details are set forth in order to provide a thorough understanding of the various aspects of different embodiments of the present invention. It will be evident, however, to one skilled in the art, that the present invention may be practiced without these specific details.

Many social network services, and particularly those with a professional or business focus, request or even require users to provide various items of personal information, including information concerning a user's educational background, employment history and career. For example, a user may be prompted to provide information concerning the schools and universities that he has attended, the dates or years of attendance, the subject matter concentration (e.g., academic concentration or major), as well as the professional certifications and/or academic degrees that he has obtained. Similarly, a user may be prompted to provide information concerning the companies for which he has worked, the employment positions (e.g., job titles) he has held, the dates of such employment, the skills he has obtained, and any special recognition or awards he has received. The data that is requested and obtained may be structured, or unstructured. Other information may be requested and provided as well, such as a professional summary, which summarizes a user's employment skills and experiences, or an objective or mission statement, indicating the user's professional or career aspirations. For purposes of this disclosure, the above-described data or information is generally referred to as member profile data or member profile information. Furthermore, each individual item of data or information may be referred to as a member profile attribute.

Consistent with some embodiments of the invention, a social network service includes a career information aggregation service, which is referred to hereinafter as the “career explorer module” or “career explorer application.” Consistent with some embodiments, the career explorer application analyzes and aggregates the member profile information of all (or some subset of) members of the social network service to provide a rich and easy to access set of tools that enable users to explore and discover a variety of information and trends concerning various industries, professions, employments positions, and/or careers. For example, with some embodiments, the career explorer application enables a user to generate and view a graphical representation of one or more potential career paths. In this context, a career path is a sequence of job titles representing employment positions. Accordingly, a career path may provide examples of a series of employment positions (e.g., identified by job titles), durations of time associated with each position, and in some instances an expected salary range for each particular employment position. The career explorer application enables a user to create or map a career path, for example, by selecting from various sets of job titles presented to the user, where the job titles are presented based on the career explorer application identifying similarities between the user's member profile information and the aggregated member profile information of other members of the social network service who actually hold employment positions with the presented job titles. Accordingly, a user is able to generate or map a career path based on suggested information associated with other members who have actually taken the same or similar career paths.

With some embodiments, the career path information that is presented to a user may be generated based in part on the user's own (actual or expected) educational background and/or employment history. As such, in addition to being capable of presenting a student with no prior work experience with a selection of potential first jobs, the career explorer application may also enable those who have already obtained an undergraduate or graduate degree from a college or university, and perhaps have several years of work experience, to explore possible next steps in their career. In some instances, a user may elect to explore potential career paths independent of their own educational background and/or employment history. Accordingly, with some embodiments, the career explorer application enables users to provide desired profile attributes, which may not accurately reflect actual possessed characteristics of the user—for example, expected or anticipated academic degrees and academic majors, as opposed to actual degrees or majors. As such, those looking to make a career change and those who may be addressing education and career concerns for the first time are able to explore various career paths.

Consistent with some embodiments, in connection with the visual representation of a particular career path, the career explorer application displays information about the viewing user's own professional network. For example, consider a career path that includes a particular employment position or job title (e.g., Junior Accountant). With some embodiments, the career explorer application enables a user to view all persons within the user's professional network who currently have the particular employment position (e.g., Junior Accountant). With some embodiments, a filtering mechanism may be used to allow the user to control the depth of his or her professional network that is analyzed and displayed, such that only first-level connections (e.g., direct connections) are displayed, or second-level connections (e.g., friends-of-friends), and so forth. Similarly, the application may allow users to configure the particular type of connections (e.g., bilateral or unilateral), and the particular social graph or social network service that is to be analyzed for purposes of identifying persons who have job titles (and thus, hold employment positions) relevant to a job title in the user's career path. By viewing various career paths, and having access to information concerning persons who currently hold employment positions within the career path, a user can reach out to people and build a professional network that may assist the user with obtaining information about job requirements, and even available jobs, as well as other valuable insights about various careers they might be interested in pursuing.

With some embodiments, the career explorer application includes certain resources particularly useful for those who may be considering career and education prospects for the first time. For example, with some embodiments, a user can select a particular job title or position within a career path, and view information, such as the type of education required for that particular position, salary information and the length of experience needed for the position, and positions or job titles that, on the aggregate, are likely to lead one to the desired and selected employment position.

Consistent with some embodiments, the career explorer application allows a user to map a career path, as well as, save, edit and compare different career paths. With some embodiments, a user can map a desired career path, for example, by selecting from a variety of starting employment positions (e.g., job titles), and then iteratively selecting additional future positions the user would like to obtain to reach his or her ultimate goal. With some embodiments, a user may select a desired position, and the career explorer application will present the user with one or more positions that may lead to the desired position. In some embodiments, a user may select or identify an employment position, and the career explorer application may identify several positions that may be obtained based on the number of years that the user has been in his current position, or based on the user's total number of years of work experience. Similarly, the career explorer application may, given a desired position, identify key experience and skill requirements necessary for following a particular career path to arrive at the desired position. With some embodiments, a user may specify starting and ending positions, and the career explorer application will identify all known paths that “connect” the starting and ending positions.

With some embodiments, the career explorer application analyzes and presents a variety of information regarding academic or educational information, including education requirements for obtaining certain positions or following certain career paths. In addition, the career explorer application identifies the particular academic majors, academic degrees, educational institutions, and professional certifications that are desired, or required, for obtaining certain positions or following certain career paths.

With some embodiments, the career explorer application includes a salary analyzing module that is configured to associate certain positions or career paths with respective salaries, and typical benefits packages, and so forth. Additionally, with some embodiments, the career explorer application is capable of deriving an expected return on investment over the lifetime of a particular career path, based on geographical considerations, career choices, education, and so forth. The salary analyzer module may be configured to access external salary information, which may be hosted at a third party server and accessed via an application programming interface (API), or may be imported periodically and stored locally.

With some embodiments, in connection with displaying a particular career path, or a position within a career path, the career explorer application will display information about network connections (persons within a user's social graph as defined by one or more online social network services) who may be of assistance in advancing a career within a certain field or company. In the context of a social network service, a network connection may be a person with whom a user has established a direct link or connection (e.g., bi-lateral connection), or a person the user is following (e.g., a unilateral connection). This enables a user to reach out to people who may be able to make appropriate introductions, as well as to meet potential career mentors.

With some embodiments, the career explorer application can display a variety of statistical information concerning different career paths and specific employment positions (e.g., job titles). For example, the career explorer application may display information concerning the age distribution of users who hold a particular position or have a particular job title. Similarly, the career explorer application may display information concerning the distribution of the total years of experience that users who hold a particular position have. The career explorer application may display a density map showing the relative number of persons who hold a position by some geographical area (e.g., state, city, county, etc.). The career explorer application may display for a particular position in a career path the most frequently attended educational institutions, or the most obtained academic major and/or academic degree for a particular employment position or job title. The career explorer application may display a list or summary of content (e.g., books, or web-based readings) that people in a particular position are currently viewing or reading, or have previously viewed or read. The career explorer application may display for a particular position in a career path the number of users who, over a particular period of time, have held the positions, thereby giving the viewer some insight into an overall hiring trend for that particular position.

With some embodiments, the career explorer application may present not only relevant current job openings, but also how one can use his network to secure or find more information about the open employment positions. For example, the career explorer application may present information about members who are in the viewing-user's network and who are employed at a particular company that has an open position that is within the viewing-user's desired career path.

With some embodiments, the career explorer application may highlight or prominently present the company profiles of potential employers, such as those companies that employ a large number of people at a particular employment position (e.g., job title) that is within the user's career path. If, for example, a user's career path includes the job title, “Software Engineer”, the career explorer application may present the user with names of companies that, based on an analysis of actual member profile data, are known to employ large numbers of people with that same title. Additionally, a user may be able to “follow” relevant companies and thereby automatically receive updates about the companies in a news feed that is customized for the user. The updates may include job postings at the company as well as notifications concerning when people get hired or leave the company.

With some embodiments, the career explorer application may provide or recommend to the viewer key reading lists, conference events, online groups, etc., that are recommended based on what other members on a particular career path are doing. With some embodiments, the career explorer application may showcase or highlight users who have similar career paths, based on their profile information. For example, after specifying or defining a desired career path by selecting a series of job titles defining career transitions, the career explorer application may identify other users of the social network service who have actually taken the same or a similar career path. As such, the career path application will actually present another user's information in the form of an interactive career path, allowing the viewer to interact with the other user's career path, for instance, by selecting and viewing certain information about the career path.

With some embodiments, the career explorer application has several social aspects to it. For instance, a user may be able to share a desired career path with another user, or, compare a career path with a peer, or, view top career paths that have been viewed and followed by others. With some embodiments, the career explorer application may allow the viewing-user to identify career paths of all peers in a particular group—such as all graduating classmates, or all persons expected to graduate in a particular year and/or with a particular academic major and degree. With some embodiments, users can view the desired career paths of other users. Accordingly, with some embodiments, a user may be able to communicate information to another user, for example, by recommending or suggesting next career steps based on a user's stated background, skills, and objectives, as well as knowledge of industry trends.

With some embodiments, the career explorer application will automatically recommend professional groups that are relevant to a particular career path. The professional groups may be online groups hosted by the social network service at which the career explorer application is hosted, or may be external, “real-world” organizations. In addition to recommending groups, the career explorer application may recommend or suggest events that are likely to be of interest to a user, based on a career path, and relevant to the career path.

With some embodiments, the career explorer application may display job satisfaction scores obtained by surveying certain sets of members of a social networking service. As such, for a particular position within a career path, an aggregate job satisfaction score may be shown. The information may be selectable, for example, allowing a user to “drill down” to find out how many people participated in the survey, and other related information. These and other aspects of the inventive subject matter will be described below in connection with the description of the various figures that follow.

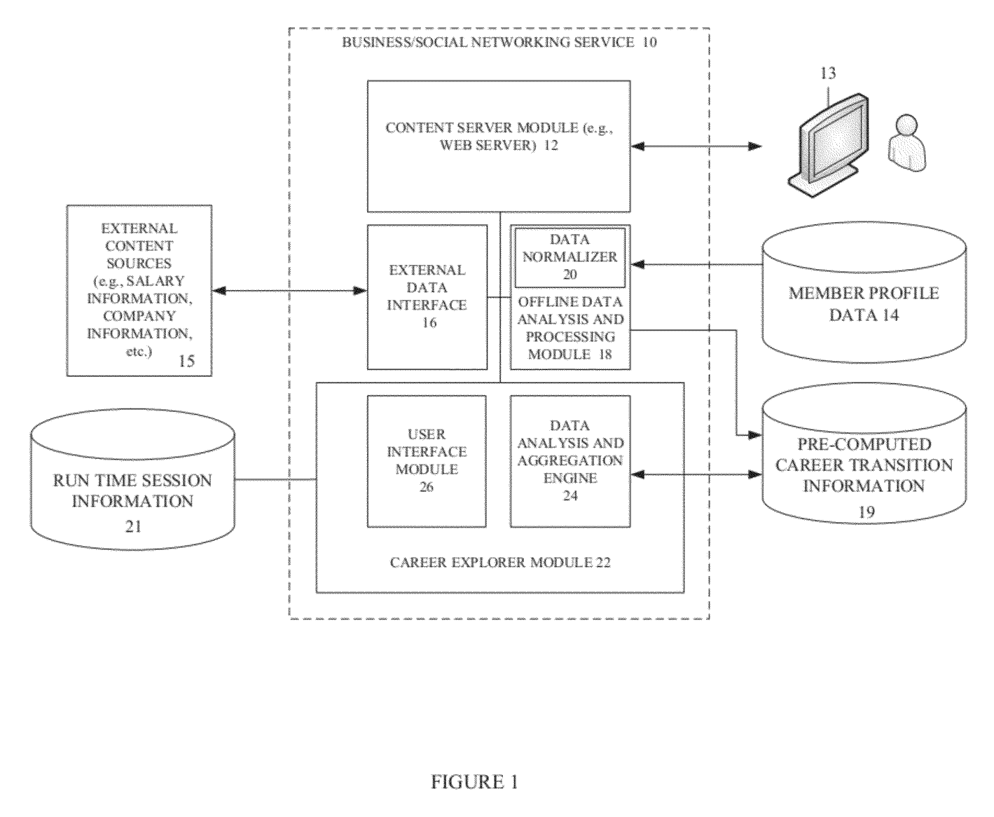

FIG. 1 is a functional block diagram illustrating various functional modules or components of a social/business network service 10, with which an embodiment of the invention might be implemented. The various functional modules illustrated in FIG. 1 may be embodied in hardware, software, or a combination thereof. Furthermore, although shown in FIG. 1 as a single set of modules, a skilled artisan will appreciate that with some embodiments, the individual components may be distributed amongst many server computers, forming a distributed, cluster-based architecture. In addition, as presented in FIG. 1, the career explorer application is represented as a module 22 integral with the social network service 10. In other embodiments, the career explorer application may be a separate web-based application that simply uses one or more sets of application programming interfaces (APIs) to leverage one or more separately hosted social network services.

As illustrated in FIG. 1, the social network service 10 includes a content server module (e.g., a web server module) 12 configured to send and receive information (e.g., web pages, or web-based content) with various web-based communication protocols to various client applications and devices, including web browser applications and/or other content rendering applications. With some embodiments, users interact with the service 10 via a web browser application, or some other content rendering application, that resides and executes on a client computing device, such as that with reference number 13 in FIG. 1. Client computing devices may include personal computers, as well as any of a wide number and type of mobile devices, such as laptop computers, tablet computers, mobile phones, and so forth. By interacting with the client computing device, a user can request and receive web pages from the service 10. With some embodiments, the web pages will prompt the user to provide various member profile attribute information (e.g., schools and/or universities attended, academic degrees received, academic majors, employment history information, and so forth), which, is then communicated to the service 10 and stored in a storage device as member profile data 14.

The service 10 includes an external data interface 16 to receive data from one or more externally hosted sources. For instance, with some embodiments, certain information about companies and/or particular job titles or employment positions (e.g., salary ranges) may be obtained from one or more external sources. With some embodiments, such data may be accessed in real-time, while in other embodiments the data may be imported periodically and stored locally at the social network service that is hosting the career explorer application.

With some embodiments, the volume of member profile data that is available for processing is extremely large. Accordingly, as shown in FIG. 1, with some embodiments, the social network service 10 includes an offline data analysis and processing module 18. With some embodiments, this processing module may be implemented with a distributed computing system, such as Apache™ Hadoop™. The processing module 18 obtains as input various attributes of member profile information, and then processes this information to ensure that is in a usable form for the career explorer application. For instance, the data normalizer module 20 will normalize various elements of data, ensuring that they conform to some standard that is used by the career explorer application. With some embodiments, the various job titles that users specify for themselves are normalized by deduplicating and disambiguating the job titles. For instance, in many cases, the same employment position will have a different job title at different companies. Accordingly, with some embodiments, the data normalizer module 20 will deduplicate job titles by mapping the different job titles, as specified in users' member profiles, to uniquely named job titles for use with the career explorer application. In addition to deduplicating job titles, with some embodiments the data normalizer will disambiguate job titles. For instance, in many cases, a particular job title may be used in two different industries, such that the two employment positions represented by the same job title are really very different. A few examples include the job titles, “associate” and “analyst.” A financial analyst may be a completely different position from a security analyst, and so forth. Accordingly, with some embodiments, the data normalizer 20 will analyze various elements of a user's member profile to determine the industry in which the user works, such that the job title for the user can be specified uniquely for that industry.

In addition to normalizing various items of information, with some embodiments, the processing module 18 computes or otherwise derives a set of probabilities for use in assessing the likelihood that a particular user, with a specific set of profile attributes, is likely to hold a particular position (e.g., job title). At least with some embodiments, these probabilities are pre-computed periodically (e.g., daily, nightly, bi-daily, weekly, every few hours, etc.). Once computed, the probabilities are stored for use with the career explorer application, as shown in FIG. 1 with reference number 19. With some embodiments, the probabilities are stored in a distributed key-value storage system, such as the open sourced storage system known as the Voldemort Project, and represented in FIG. 1 as the data analysis and aggregation engine with reference number 24. The probabilities that are generated include conditional probabilities that represent the likelihood that a user will have a particular job title, given a particular member profile or characteristic possessed by the user. At run-time, these stored probabilities are then quickly retrieved, based on the profile attributes of the user, and then used with one or more probability vectors to identify the particular job titles that most closely correspond with the user's profile attributes. With some embodiments, the profile attributes specified by the user for use with the career explorer application may be separately stored with run-time session information, as illustrated in FIG. 1 with reference number 21.

As illustrated in FIG. 1, the career explorer module 22 includes a data analysis and aggregation engine 24, and a user interface (UI) module 26. The data analysis and aggregation engine analyzes and aggregates the career and professional information of the social network service members. For example, the aggregation engine identifies employment positions, represented by job titles, which are most likely to be of interest to a user by calculating a probability score for each job title, with conditional probabilities specified in vector form that correspond with the profile attributes of the user. The UI module includes logic for presenting the information in various formats, for example, as shown in the various example user interfaces presented in the attached figures.

As described below, with some embodiments, after providing some basic background information, such as an academic major and degree, as well as an expected or desired industry, and perhaps a geographical location, the career explorer module will present the user with a set of job titles the user is likely to hold, based on the analysis of the profile information of the members of the social network service. After the user selects a first job title, the career explorer module presents a visual representation of a career path for the user, including this first selected job title as a first employment position in the career path. Next, the career explorer module will present the user with a second set of job titles, where the job titles in the second set of user-selectable job titles are again selected by the career explorer module based on the derived probabilities (derived with members' profile information) and a presumed number of years of experiencing working at the first user-selected employment position, as represented by the job title selected by the user in the first set of job titles. Accordingly, by repeating this process, the user can build out a career path existing of a series of user-selected job titles. With some embodiments, each job title in the visual representation of the career path is presented with additional information, such as the expected number of year of work experience that the user is likely to have in that particular employment position before transitioning to a new job title, as well as salary information for the job title, and so forth.

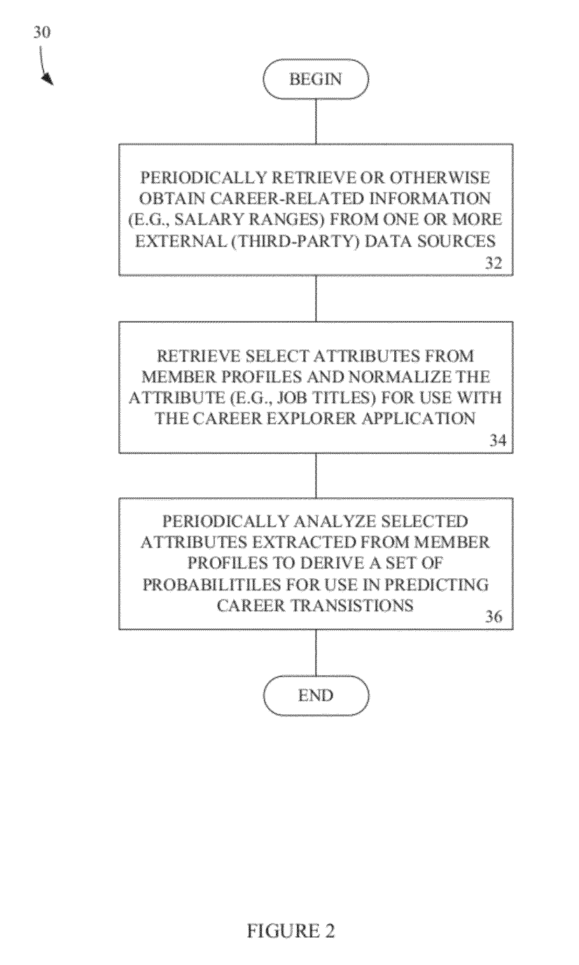

With some embodiments, the career explorer application will pre-compute various items of information, thereby ensuring that the career explorer application provides a real-time experience to users. For example, some information is processed to ensure that it is conditioned for use with the career explorer application. For instance, as indicated by method operation 32 in the method 30 illustrated in FIG. 2, with some embodiments, various elements of career-related information are retrieved or otherwise obtained from one or more external data sources. For instance, this particular data may be hosted by a third-party and made available via an API. With some embodiments, this information may include company-specific information or salary information about certain employment positions and so forth. With some embodiments, this information is retrieved and stored locally with the servers that are executing the career explorer application. However, with some embodiments, some or all of this information could be requested in real-time, for example, as a user of the career explorer application is requesting the information.

At method operation 34, certain attribute information from the member profiles of members of a social network service are retrieved and analyzed for the purpose of normalizing the information for use with the career explorer application. For instance, with some embodiments, job titles may be specified (as opposed to selected) by the members of the social network service and therefore will not be standardized across companies and industries. As such, with some embodiments, a normalizer module will analyze the profile information from which certain job titles are extracted to ascertain an industry specific job title. Accordingly, with some embodiments, the career explorer application will utilize a set of unique, industry specific job titles. Of course, other attributes may also be normalized when appropriate.

Finally, at method operation 36, select elements of profile attribute information of all social network members are analyzed to derive a set of probabilities for use in predicting a set of job titles that a user is likely to have, and career transitions the user is likely to make, based on a minimal set of profile attributes the user has specified. With some embodiments, the probabilities include conditional probabilities that represent the probability that a user is to hold a particular job title, given a particular characteristic of the user as specified in a profile attribute associated with the user. For instance, a conditional probability may be derived to represent the probability that a user will hold the job title, “CEO”, if the user has a Masters degree in business administration (MBA). Accordingly, by comparing a user's actual or specified profile attributes with the correct set of conditional probabilities, a set of probabilities corresponding to the most likely job titles for a particular user can be generated.

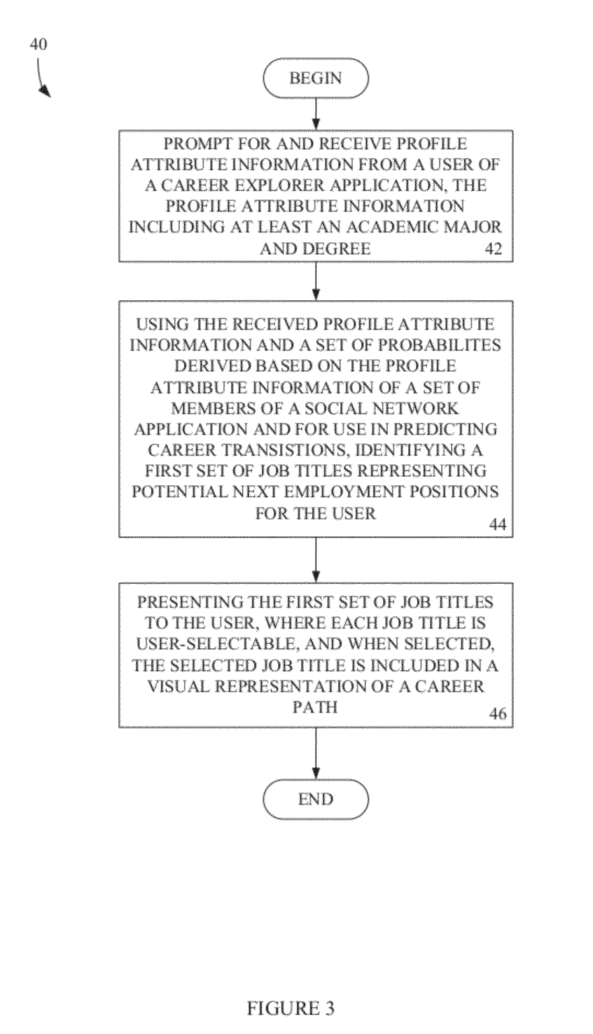

FIG. 3 is a flow diagram illustrating the method operations that occur, at run-time, during a method 40 for generating a visual representation of a career path for a user, according to some embodiments of the invention. At method operation 42, a user is prompted to provide various profile attribute information for use with the career explorer application. For example, with some embodiments, the career explorer application will prompt a user to provide or specify an academic major and degree, as well as an expected industry in which the user would like or expects to work. With some embodiments, the career explorer application may prompt the user to specify the geographical location where the user desires to work, and/or the school or university from which he received his degree. Of course other data may be prompted for and received as well.

Once the data has been provided by the user, or otherwise obtained for the user, at method operation 44 the user's profile attribute information is used, in connection with the pre-computed probabilities (based on the analysis of the members' profile data) to identify and then present (at method operation 46) to the user a first set of job titles that the user is likely to hold, in view of the profile attributes (e.g., academic major and degree, etc.) provided by the user. With some embodiments, the job titles associated with a predetermined number of highest probabilities are presented to the user as user-selectable job titles. In addition to simply presenting the job titles, additional information about the particular employment positions represented by the job titles are presented as well. For example, the salary range that corresponds with each job title may be presented. Similarly, the average duration of time that a person is likely to hold the employment position before transition to a new job title may be presented. When a user selects a particular job title in the first set of job titles presented to the user, a visual representation of a career path is then presented to the user with the first selected job being positioned in the career path to show that is the first employment position for the user.

With some embodiments, the method operations shown in FIG. 3 are repeated a number of times until the user has selected a certain number of job titles, or has selected job titles with average durations that, together, meet or exceed some predetermined threshold number of years for a career. With each iteration, the job titles that are presented to the user for selection are identified by the career explorer application based on the profile information provided by the user and the pre-computed probabilities (derived by analysing actual member profile data). In addition, the career explorer application assumes a number of years of work experience for each selected job title, such that presentation of the second set of job titles will be based on a presumption that the user actually worked at the employment position associated with the first user-selected job title a certain number of years, and thus has a number of years of work experience for the first job title.

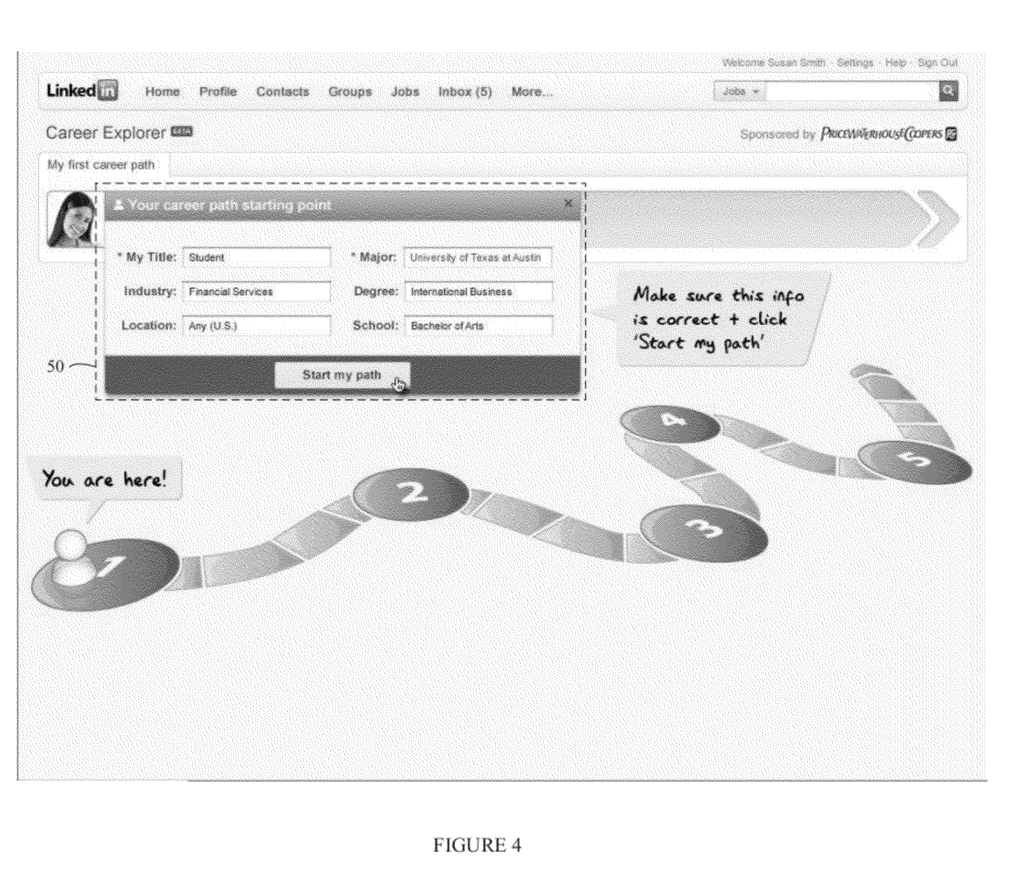

FIG. 4 is an example of a user interface for a web-based career explorer application via which a user is prompted to provide various profile attribute information, for use by the career explorer application in predicting or identifying a set of job titles likely to be of interest to the user. As shown in the example user interface of FIG. 4, the dialog or text box with reference number 50 includes fields in which the user is prompted to provide certain profile attribute information, to include: a current title; an academic major and degree; an expected or desired industry; an expected, actual, or desired geographical location; and a school or university from which the degree is, or has been, granted. Of course, in alterative embodiments, more or less profile information may be requested. Furthermore, with some embodiments, some or all of the information may be automatically obtained from a member's existing profile information, as opposed to prompting for the information separately.

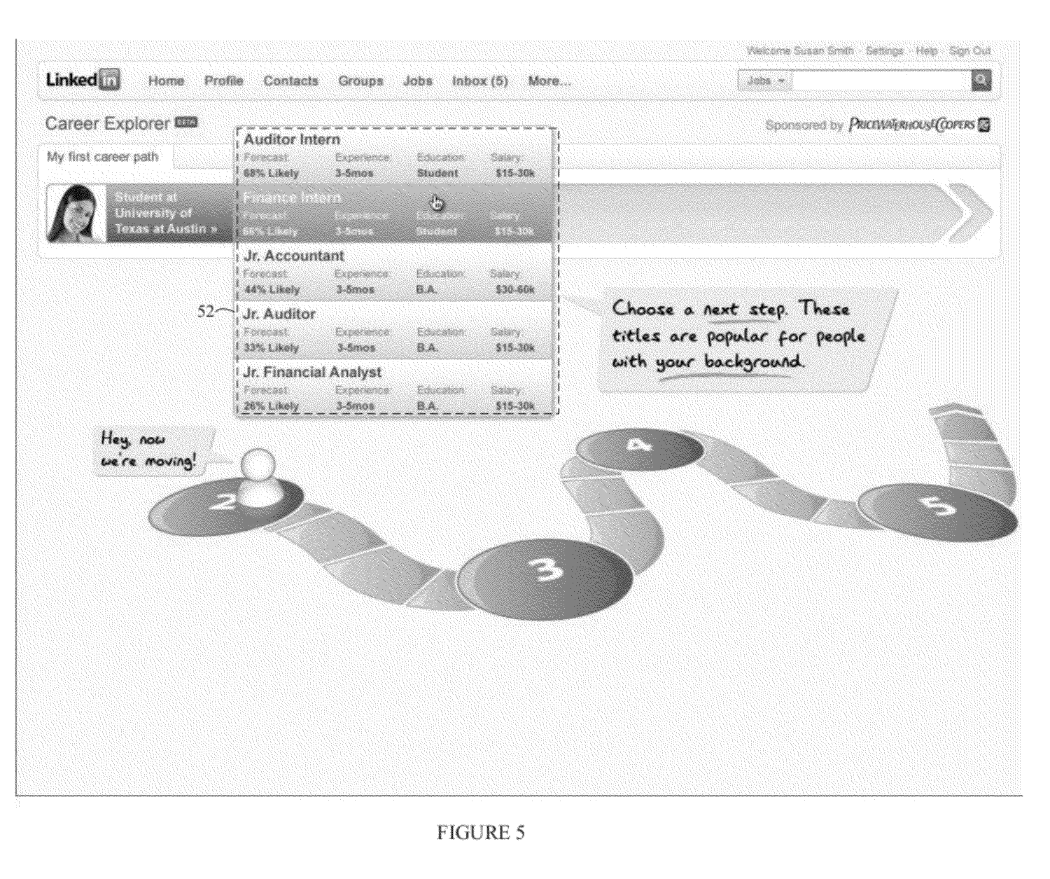

After the user has provided and submitted the profile information the user is presented with a first set of user-selectable job titles, as shown in the dialog or text box with reference number 52 in the example user interface presented in FIG. 5. In this example, the user is presented with five user-selectable job titles. With each job title, additional information is presented, such as the expected years of experience that a user is likely to have at a particular employment position, represented by the job title, before transitioning to a new employment position. In addition, the desired or expected level of education for each job title may be presented. Similarly, an average salary or range of salary may be provided for each job title.

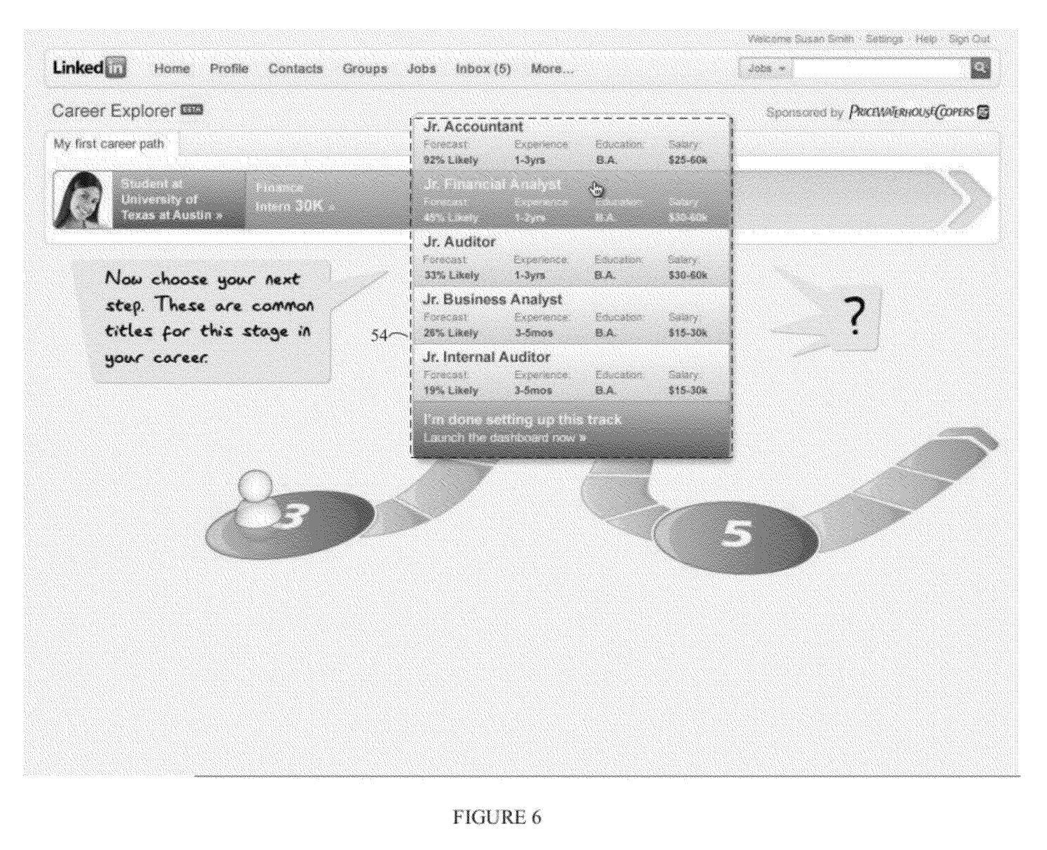

Upon selecting a particular job title for inclusion in the user's career path, the career explorer application will use the selected job title, in addition to the previously provided profile information to identify and present a second set of job titles that the user might hold, as determined with the probabilities that were derived for use in predicting job titles, and career transitions. Accordingly, as shown in FIG. 6, there is an example of a user interface for a web-based career explorer application presenting a user with a second set of user-selectable job titles for inclusion in a career path for the user (with reference number 54). This process is repeated until the user has built out a career path existing of a predetermined number of job titles, or a duration of years of experience that meets or exceeds some predefined, or user-selected threshold.

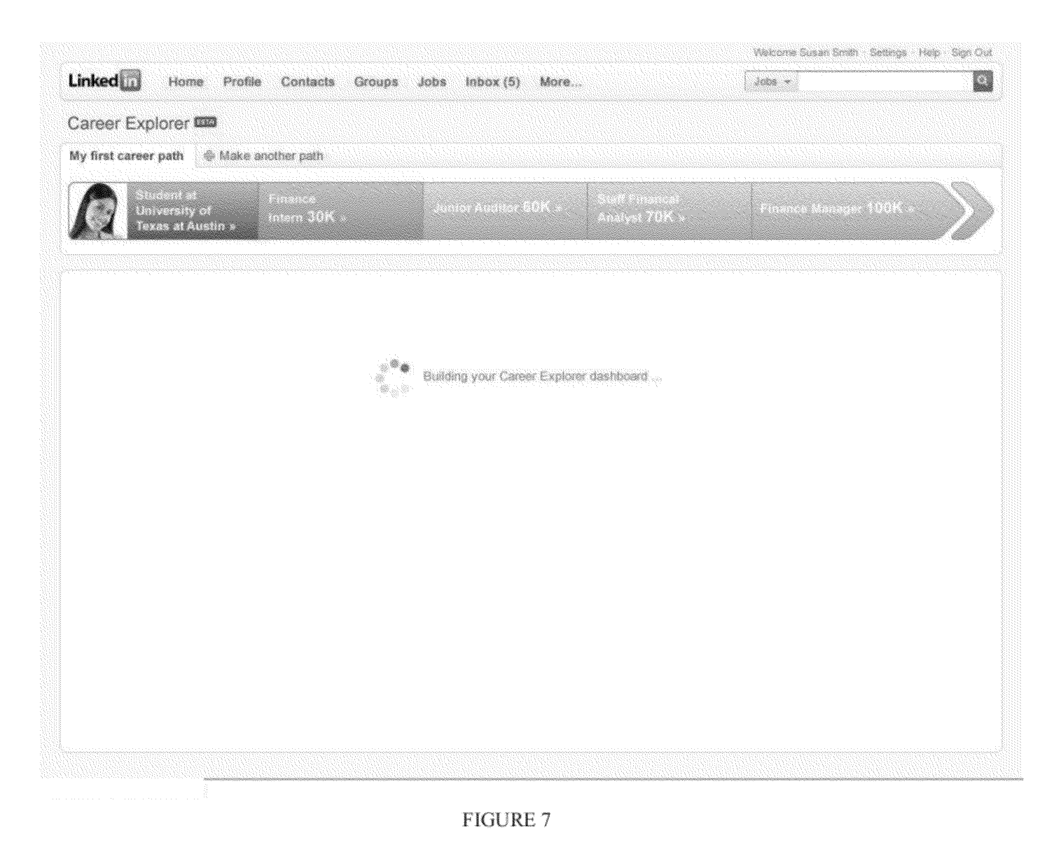

Once a user has selected a number of job titles, and a career path has been defined, the career explorer application analyzes the career path to identify and present career-, industry- and job-related information, relevant to various aspects of the user's career path. For example, as shown in FIG. 7, the user has completed the generation of a career path, which is visually presented in the example user interface. Accordingly, the career explorer application displays a message indicating that a career explorer dashboard is being generated, where the dashboard presents the interactive information concerning the industry, career, and job titles in the user's career path.

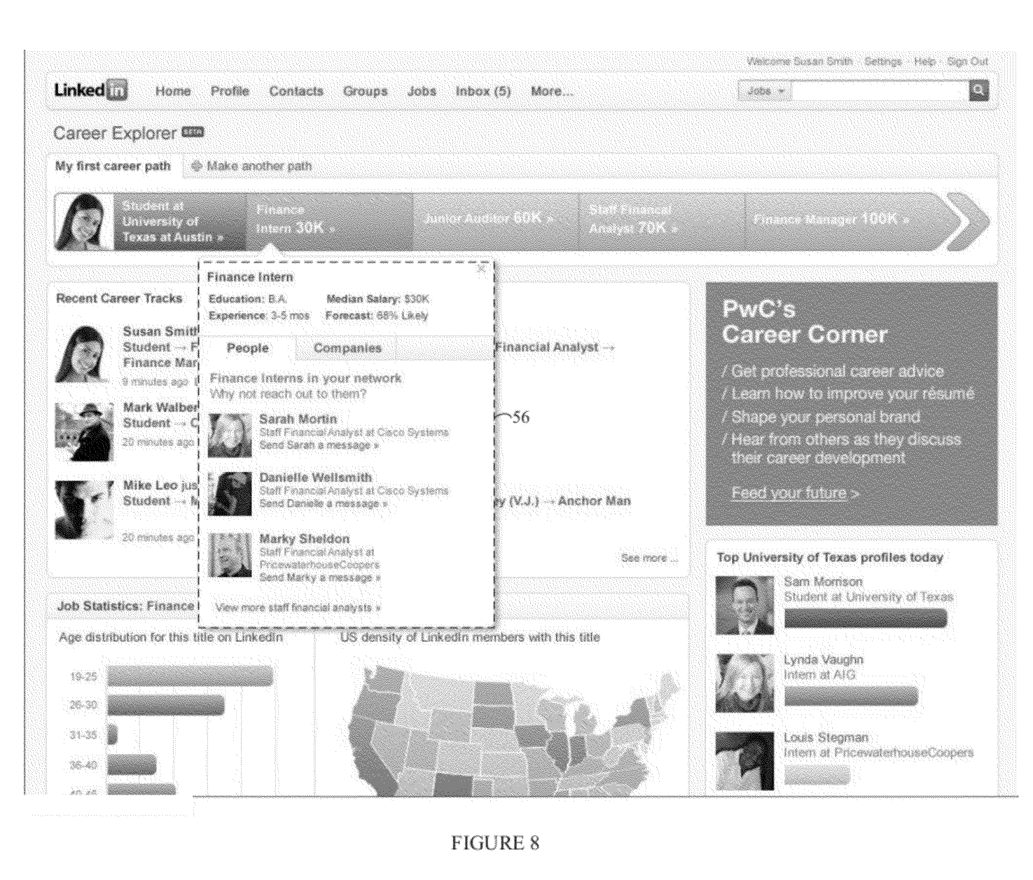

FIG. 8 is an example user interface for a web-based career explorer application presenting a visual representation of an interactive career path for a user and information about persons with whom the user is connected and who have some connection with a particular job title in the user's career path, according to some embodiments. As illustrated in FIG. 8, the user has selected the first job title (e.g., “Finance Intern”) in the user's visual representation of the career path. When a particular job title is selected in the career path, the user is presented with an option to view people or companies related to the job title. In this example of FIG. 8, the user has selected the “People” tab, and is presented with a list of people in the user's network, who are in some way connected to the job title. For example, the persons presented in the list may have the same job title, may have previously held the job title, and/or may simply work at a company that employs people with the selected job title.

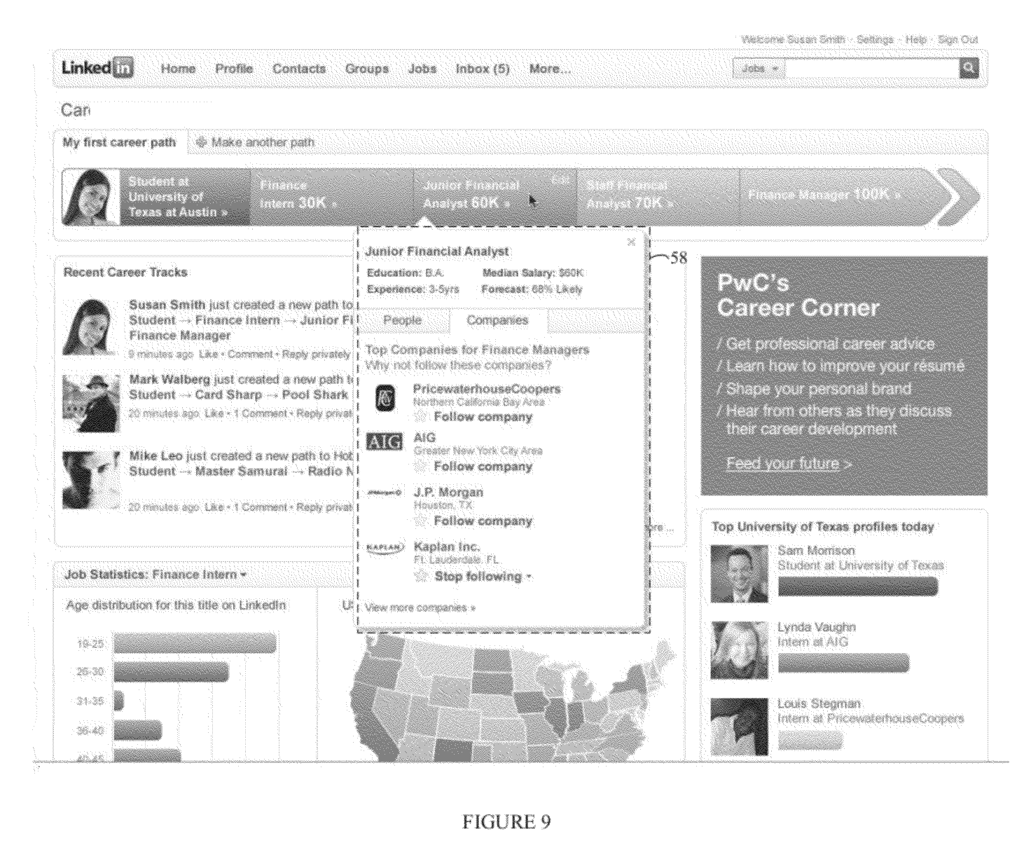

As illustrated in FIG. 9, in addition to displaying information about a user's connections, the career explorer application may present information about different companies, when the companies are relevant in some way with respect to the selected job title. For instance in FIG. 9, the box with reference number 58 is showing various companies related to the job title, “Junior Financial Analyst”. These companies may be selected for presentation, for example, because they employ a high number of people with the selected job title, or because they have one or more job listings, or job openings that correspond with the selected job title. With some embodiments, a user can select a graphical user interface element displayed in connection with the presentation of a particular company to subscribe to the company. By subscribing to the company, the user will be presented with various information about the company. Such information may be presented, for example, in a customized news feed for the user.

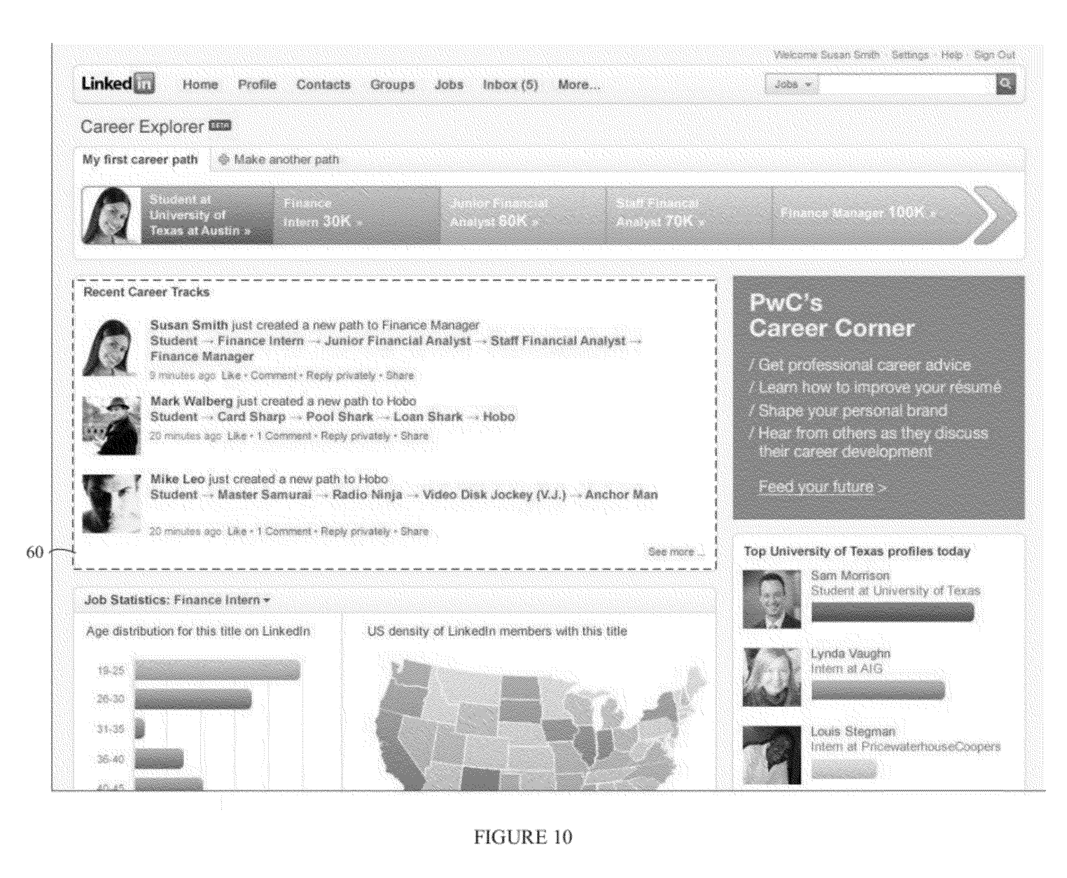

In the graphical user interface element corresponding with reference number 60 in FIG. 10, various career paths of other users are shown. For instance, with some embodiments, once a user defines or builds a career path, the career path can be shared with others. Accordingly, with some embodiments, users may provide comments on others' career paths, as well as recommend to others items of information (e.g., companies, job listings, groups, etc.) that are relevant to a user's career path.

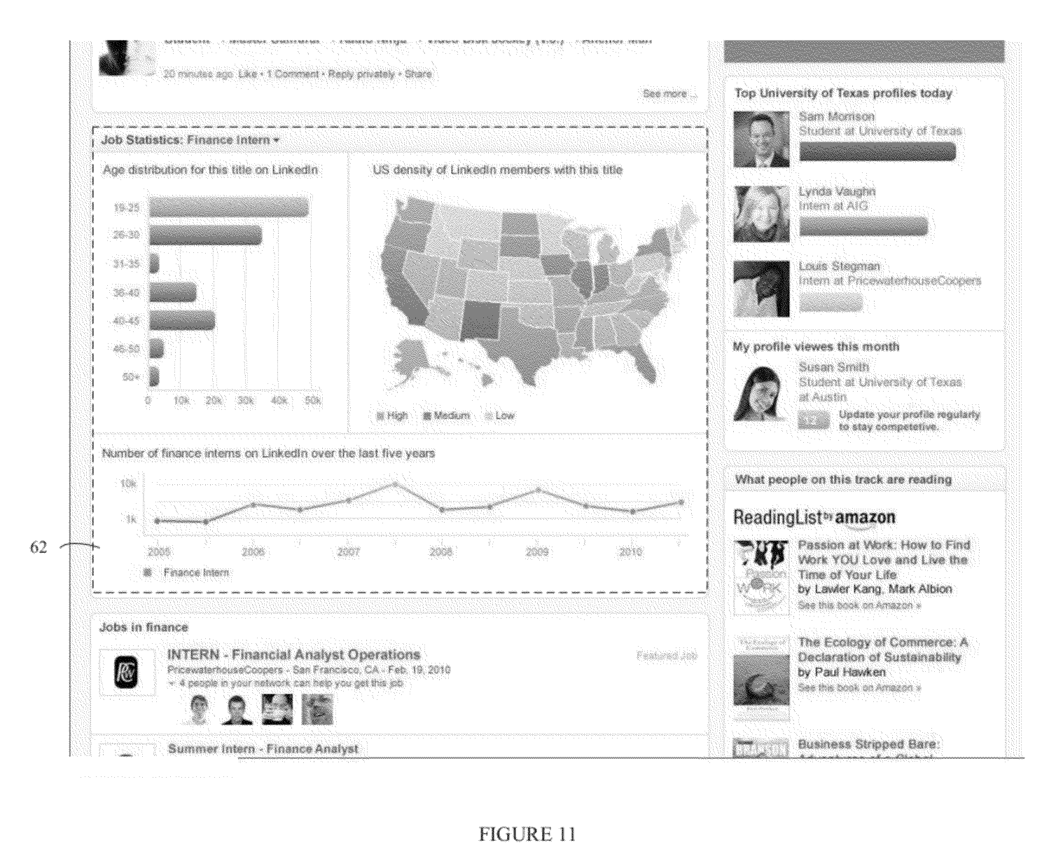

As illustrated by the user interface element with reference number 62 in FIG. 11, the career explorer application may present statistical information concerning a particular job title, career or industry. For example, as illustrated in FIG. 11, information concerning the age distribution for the job title, “Finance Intern” is presented to the user. Similarly, a density map showing the highest concentration (by state) of persons having the job title “Finance Intern” is presented. Finally, a graph showing the number of members who have held the title “Finance Intern” over a given number of years is shown.

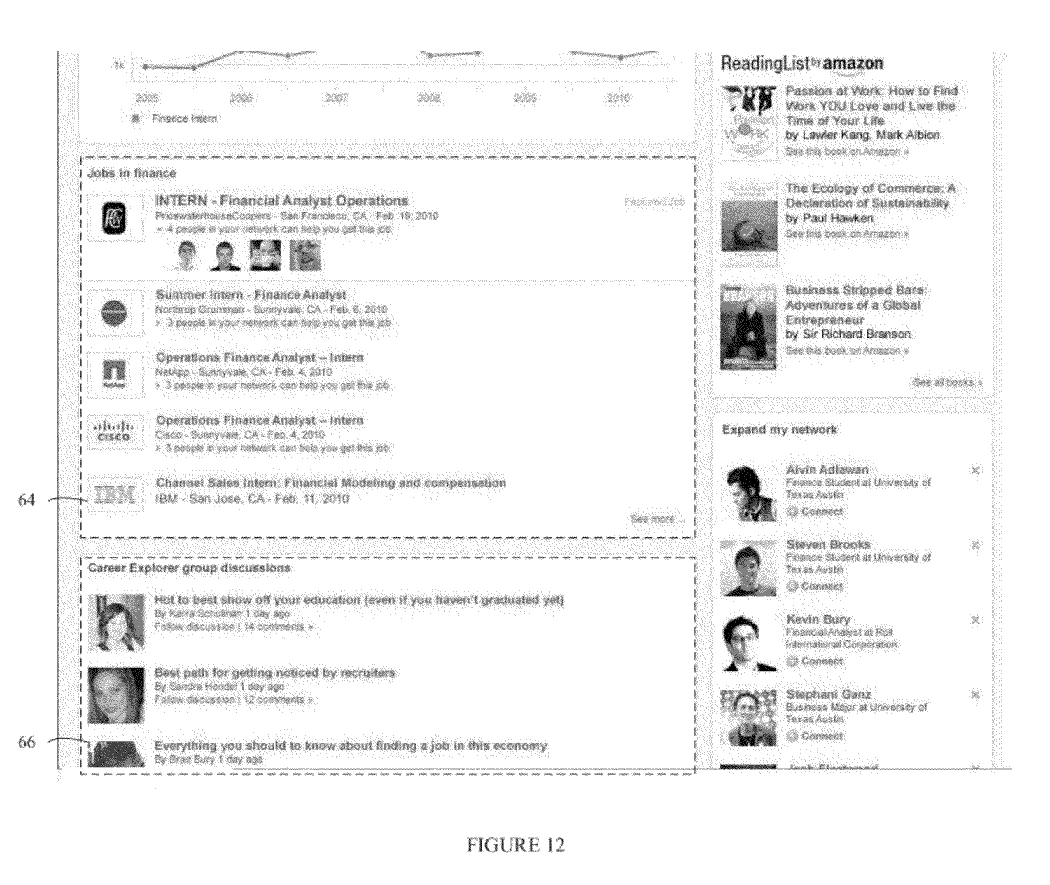

FIG. 12 is an example user interface for a web-based career explorer application presenting information concerning various job openings and groups associated with a selected job title in a career path, according to some embodiments of the invention. As shown with reference number 64 in FIG. 12, with some embodiments, relevant job listings may be presented. For example, if there are job listings hosted by the social network service, or by some third-party job listing service, and the job listings correspond with a selected job title from the career path, the job listings may be presented to the user. Similarly, as shown with reference number 66, groups that are relevant to a particular job title in the career path may be presented to the user.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

FIG. 7 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A computer-implemented method comprising:
analyzing profile attribute information extracted from the profiles of members of a social network service to derive a set of probabilities for use in predicting career transitions;
prompting for and receiving profile attribute information of a user of the social network service, the profile attribute information including an academic major and an academic degree for the user;
using the received profile attribute information of the user and the set of probabilities for use in predicting career transitions, identifying a first set of job titles representing next employment positions the user is likely to have; and
presenting the first set of job titles to the user.

2. The computer-implemented method of claim 1, wherein presenting the first set of job titles to the user includes presenting, for each job title in the first set of job titles, an average number of years of work experience a person is likely to have at the particular employment position represented by the job title, based on the analysis of the profile attribute information.

3. The computer-implemented method of claim 1, wherein presenting the first set of job titles to the user includes presenting, for each job title in the first set of job titles, a salary range for the employment position represented by the job title.

4. The computer-implemented method of claim 1, wherein the profile attribute information extracted from the profiles of members of the social network service include any one or more of: a member's current job title, a member's total years of work experience; a member's academic major; a member's academic degree; a member's geographic location; and, an educational institution attended by a member.

5. The computer-implemented method of claim 1, wherein identifying the first set of job titles representing next employment positions the user is likely to have includes using a Bayesian predictive model to identify the first set of job titles based on the derived set of probabilities for use in predicting career transitions.

6. The computer-implemented method of claim 1, further comprising:
prior to analyzing the profile attribute information extracted from the profiles of members of the social network service, normalizing the job titles of the members of the social network service by deduplicating and disambiguating job titles to derive a set of unique, industry-specific job titles.

7. The computer-implemented method of claim 1, wherein the set of probabilities for use in predicting career transitions includes conditional probabilities representing the probability that a member with a particular profile attribute will have a particular job title.

8. The computer-implemented method of claim 1, wherein presenting the first set of job titles to the first user includes prompting the first user to select a job title for inclusion in a career path for the user, the career path represented by a sequence of job titles, the method further comprising:
detecting the user's selection of a job title in the first set of job titles, and in response, presenting a visual representation of the career path of the user with the job title selected from the first set of job titles.

9. The computer-implemented method of claim 8, further comprising
using the received profile attribute information of the user, the set of probabilities for use in predicting career transitions, and a presumed number of years of work experience a person is likely to have at the particular employment position represented by the job title selected by the user from the first set of job titles, identifying a second set of job titles representing employment positions the user is likely to have subsequent to the employment position represented by the job title selected by the user from the first set of job titles;
presenting the second set of job titles to the user; and
detecting the user's selection of a job title in the second set of job titles, and in response, updating the visual representation of the career path of the user with the job title selected from the second set of job titles.

10. The computer-implemented method of claim 9, further comprising:
presenting the visual representation of the career path of the user with a sequence of job titles, each job title representing an employment position and having an associated number of years a person is expected to hold the employment position, based on the analysis of the profile attribute information.

11. The computer-implemented method of claim 10, further comprising:
analyzing profile attribute information of the user to identify members of the social network service i) with whom the user has established connections, and ii) who hold an employment position represented by a job title in the visual representation of the career path presented to the user; and
displaying information concerning one or more of the identified members of the social network service.

12. The computer-implemented method of claim 10, further comprising:
analyzing profile attribute information of the user to identify members of the social network service i) with whom the user has established connections, and ii) who are employed at a company that has one or more job listings posted to a job listing service, the job listing having a job title that corresponds with an employment position represented by a job title in the visual representation of the career path presented to the user; and
displaying, with the visual representation of the career path of the user, information concerning one or more of the identified members of the social network service.

13. The computer-implemented method of claim 10, further comprising:
identifying one or more companies at which one or more members of the social network service hold employment positions represented by a job title included in the visual representation of the career path of the user; and
displaying, with the visual representation of the career path of the user, information concerning one or more of the identified companies.

14. The computer-implemented method of claim 10, further comprising:
identifying one or more job listings for an employment position represented by a job title included in the visual representation of the career path of the user; and
displaying, with the visual representation of the career path of the user, information concerning the one or more identified job listings.

15. A computer-readable storage medium storing instructions, which, when executed by a processor of a server, cause the server to:
analyze profile attribute information extracted from the profiles of members of a social network service to derive a set of probabilities for use in predicting career transitions;
prompt for and receive profile attribute information of a user of the social network service, the profile attribute information including an academic major and an academic degree for the user;
using the received profile attribute information of the user and the set of probabilities for use in predicting career transitions, identify a first set of job titles representing next employment positions the user is likely to have; and
present the first set of job titles to the user.

16. The computer-readable storage medium of claim 15, including further instructions which, when executed, cause the server to present, for each job title in the first set of job titles, an average number of years of work experience a person is likely to have at the particular employment position represented by the job title, based on the analysis of the profile attribute information.

17. The computer-readable storage medium of claim 15, including further instructions which, when executed, cause the server to present, for each job title in the first set of job titles, a salary range for the employment position represented by the job title.

18. The computer-readable storage medium of claim 15, wherein the profile attribute information extracted from the profiles of members of the social network service include any one or more of: a member's current job title, a member's total years of work experience; a member's academic major; a member's academic degree; a member's geographic location; and, an educational institution attended by a member.

19. The computer-readable storage medium of claim 15, wherein identifying the first set of job titles representing next employment positions the user is likely to have includes using a Bayesian predictive model to identify the first set of job titles based on the derived set of probabilities for use in predicting career transitions.

20. The computer-readable storage medium of claim 15, including further instructions which, when executed, cause the server to:
normalize the job titles of the members of the social network service by deduplicating and disambiguating job titles to derive a set of unique, industry-specific job titles, prior to analyzing the profile attribute information extracted from the profiles of members of the social network service.
